(19) United States
(12) Patent Application Publication
(10) Pub. No.: US 2006/0242707 A1
(43) Pub. Date: Oct. 26, 2006

(54) System and method for protecting a computer system

(75) Inventors: Alibaba Tang, Chongqing (CN); Sunshine Zhang, Chongqing (CN)

Correspondence Address: ARENT FOX PLLC, 1050 CONNECTICUT AVENUE, N.W., SUITE 400, WASHINGTON, DC, 20036, US

(73) Assignee: FARSTONE TECH., INC.

(21) Appl. No.: 11/409,263

(22) Filed: Apr. 24, 2006

(30) Foreign Application Priority Data
Apr. 22, 2005 (TW) 94112948

(51) Int. Cl. G06F 12/14

(52) U.S. Cl. 726/23

(57) ABSTRACT

A system and methodology that securely protects data in a computer system. According to the invention, security system is suitable for a computer system having at least one file stored therein. The security system comprises a creating module, a monitoring module, a recording means and a detecting module. The creating module creates at least one recovery point. The monitoring module monitors a change operation to the at least one file. The recording means records predetermined message of the change operation. The detecting module detects whether or not the computer system is being infected by virus, spyware, Trojan or other security threats. The creating module creates the at least one recovery point prior to the change operation. Message of the at least one recovery point is respectively recorded in the recording means. One of the at least one recovery point is retrieved for recovery operation.

### CROSS-REFERENCE TO RELATED APPLICATIONS

This is a 35 U.S.C. § 119 of Taiwan Application No. 94112948 filed Apr. 22, 2005. The disclosure of the prior application is hereby incorporated by reference herein in its entirety.

### BACKGROUND OF THE INVENTION

1. Field of the Invention

The present invention relates generally to a security technique for a computer system, and more particularly to a backup/recovery system and method that securely protects a computer system.

2. Description of Prior Art

One particular problem that has plagued computers has been computer viruses and worms. A computer virus is a section of code that is buried or hidden in another program. Once the program is executed, the code is activated and attaches itself to other programs in the system. Infected programs in turn copy the code to other programs. The effect of such viruses can be simple pranks that cause a message to be displayed on the screen or more serious effects such as the destruction of programs and data. Another problem in the prior art is worms. Worms are destructive programs that replicate themselves throughout disk and memory using up all available computer resources eventually causing the computer system to crash. Obviously, because of the destructive nature of worms and viruses, there is a need for eliminating them from computers and networks.

Currently, conventional backup/recovery software creates recovery points to backup and/or recover data. For example, the conventional backup/recovery software, such as the Ghost software developed by Symantec Corporation, includes a backup program to back up all data stored in selected partitions of the hard disk to a file. In addition, it further includes a recovery program for restoring the data from the file to the selected partitions of the hard disk.

Current techniques available in the conventional backup/recovery software provide no notion of how to solve the problem of computer viruses and worms, not to mention the result of incapable virus-detection. Moreover, such conventional software does not prompt the user to create recovery points against viruses in good time. The user usually doesn't aware danger from the interconnection of computer into networks completely.

### SUMMARY OF THE INVENTION

The present invention provides a backup/recovery system and method to resolve the foregoing problems faced by the conventional backup/recovery software. The present invention also has the advantage of providing high protection to the computer system.

An object of the present invention is to provide a backup/recovery system and method, wherein recovery points and messages regarding recovery operation thereof can be recorded. The computer system can return to a preceding state based on the messages.

Another object of the present invention is to provide a backup/recovery system and method, which can integrate techniques of detecting viruses with backup/recovery techniques. Moreover, the unknown viruses can be eliminated as well.

In accordance with an aspect of the present invention, a security system is suitable for a computer system having at least one file stored therein. The security system comprises a creating module, a monitoring module, a recording means and a detecting module. The creating module creates at least one recovery point. The monitoring module monitors a change operation to the at least one file. The recording means records predetermined message of the change operation. The detecting module detects whether or not the computer system is being infected by virus, spyware, Trojan or other security threats. The creating module creates the at least one recovery point prior to the change operation. Message of the at least one recovery point is respectively recorded in the recording means. One of the at least one recovery point is retrieved for recovery operation.

In the preferred embodiment of the invention, the message of the at least one recovery point includes creating time of the at least one recovery point. The retrieved recovery point is created prior to the appearance of infection of virus, spyware, Trojan or other security threats. The retrieved recovery point is the latest created one.

In accordance with another aspect of the present invention, a security system is suitable for a computer system having at least one file stored therein. The security system comprises a creating module, a monitoring module, a recording means and a processing module. The creating module creates at least one recovery point. The monitoring module monitors a change operation to the at least one file. The recording means records predetermined message of the change operation. The processing module processes a recovery operation after the computer system is being infected by virus, spyware, Trojan or other security threats, in accordance with message of the at least one recovery point.

In the preferred embodiment of the invention, the message of the at least one recovery point includes creating time of the at least one recovery point. The retrieved recovery point is created prior to the appearance of infection of virus, spyware, Trojan or other security threats. The retrieved recovery point is the latest created one.

The present invention may best be understood through the following description with reference to the accompanying drawings, in which:

### BRIEF DESCRIPTION OF THE DRAWINGS

FIG. 1 shows a schematic block diagram of a security system of a preferred embodiment according to the present invention.

FIG. 2 shows a schematic block diagram of a security system of another preferred embodiment according to the present invention.

FIG. 3 shows a schematic flow chart of a security method of the preferred embodiment according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purpose of illustration and description only. It is not intended to be exhaustive or to be limited to the precise form disclosed.

The present invention describes a technique for a computer system to protect data. With the technique of the present invention, the users can restore the computer system to a previous state if the computer system has been infected by virus-related threats. Therefore, the drawbacks faced by the prior arts can be solved completely.

According to the preferred embodiment of the present invention, a security system is suitable for a computer system having at least one file stored therein. The security system comprises a creating module, a monitoring module, a recording means and a detecting module. The creating module creates at least one recovery point. The monitoring module monitors a change operation to the at least one file. The recording means records predetermined message of the change operation. The detecting module detects whether or not the computer system is being infected by virus, spyware, Trojan or other security threats. The creating module creates the at least one recovery point prior to the change operation. Message of the at least one recovery point is respectively recorded in the recording means. One of the at least one recovery point is retrieved for recovery operation.

The message of the at least one recovery point includes creating time of the at least one recovery point. The retrieved recovery point is created prior to the appearance of infection of virus, spyware, Trojan or other security threats. The retrieved recovery point is the latest created one.

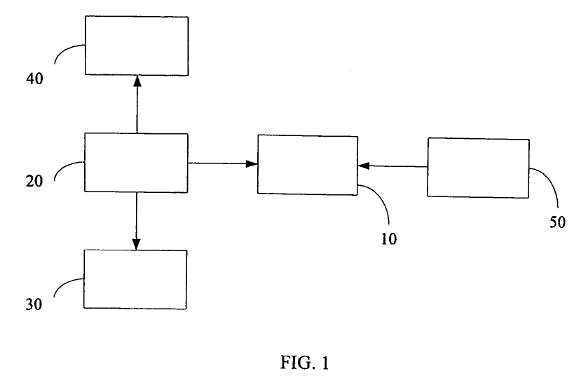

Referring to FIG. 1, a schematic block diagram of a security system of a preferred embodiment according to the present invention is shown. The security system of the present invention is suitable for a computer system, which stores at least one file 10 stored therein. The security system comprises a creating module 30, a monitoring module 20, a recording means 40 and a detecting module 50.

The at least one file 10 may be all files contained in a hard disk of the computer system. The creating module 30 creates at least one recovery point. The monitoring module 20 monitors a change operation to the at least one file 10. The change operation to the at least one file 10 may be write, erase, revise such file 10, etc. prior to the change operations of the at least one file 10 occur, the creating module 30 creates the at least one recovery point.

The recording means 40 records predetermined message of the change operation. Message of the at least one recovery point is respectively recorded in the recording means 40. The message of the at least one recovery point includes creating time of the at least one recovery point.

The detecting module 50 scans whether or not the computer system is being infected by virus, spyware, Trojan or other security threats. If the computer system is infected by virus, spyware, Trojan or other security threats, the detecting module 50 can delete the virus.

Otherwise, the computer system retrieves one of the at least one recovery point for recovery operation. The retrieved recovery point is previously created prior to the appearance of infection of virus, spyware, Trojan or other security threats. The retrieved recovery point is the latest created one.

According to the preferred embodiment of the present invention, there is another security system suitable for a computer system. The computer system has at least one file stored therein. The security system comprises a creating module, a monitoring module, a recording means and a processing module. The creating module creates at least one recovery point. The monitoring module monitors a change operation to the at least one file. The recording means records predetermined message of the change operation. The processing module processes a recovery operation after the computer system is being infected by virus, spyware, Trojan or other security threats, in accordance with message of the at least one recovery point.

The message of the at least one recovery point includes creating time of the at least one recovery point. The retrieved recovery point is created prior to the appearance of infection of virus, spyware, Trojan or other security threats. The retrieved recovery point is the latest created one.

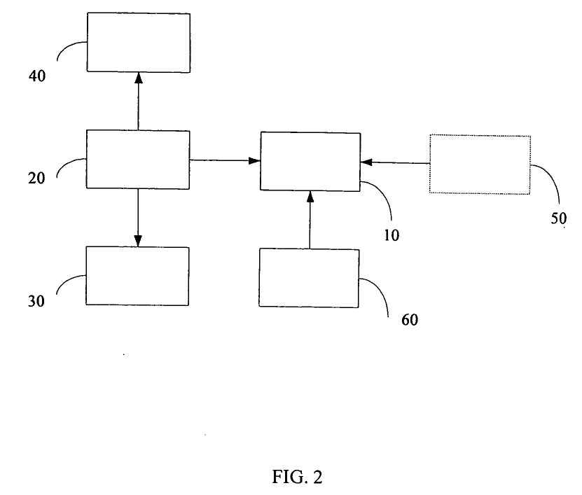

Referring to FIG. 2, a schematic block diagram of a security system of another preferred embodiment according to the present invention is shown. According to the present invention, the security system is suitable for a computer system. The computer system has at least one file 10 stored therein. The security system comprises a creating module 30, a monitoring module 20, a recording means 40, a detecting module 50 and a processing module 60. The detecting module 50 is an option, not a requirement.

The at least one file 10 may be all files contained in a hard disk of the computer system. The creating module 30 creates at least one recovery point. The monitoring module 20 monitors a change operation to the at least one file 10. The change operation to the at least one file 10 may be write, erase, revise such file 10, etc. prior to the change operations of the at least one file 10 occur, the creating module 30 creates the at least one recovery point.

The recording means 40 records predetermined message of the change operation. Message of the at least one recovery point is respectively recorded in the recording means 40. The message of the at least one recovery point includes creating time of the at least one recovery point.

The processing module 60 can dealt with all kinds of viruses, even unknown viruses. The unknown viruses may destroy programs and data. The processing module 60 can processes a recovery operation after the computer system is being infected by virus, spyware, Trojan or other security threats, in accordance with message of the at least one recovery point.

The message of the at least one recovery point includes creating time of the at least one recovery point. The computer system retrieves one of the at least one recovery point for recovery operation. The retrieved recovery point is previously created prior to the appearance of infection of virus, spyware, Trojan or other security threats. The retrieved recovery point is the latest created one.

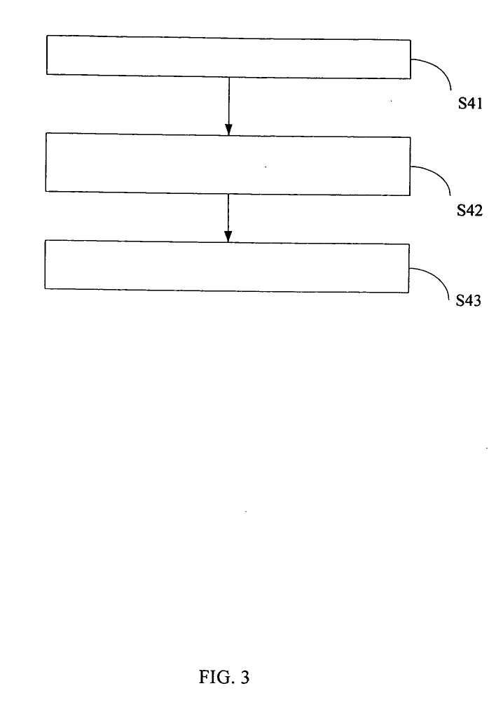

Referring to FIG. 3, a schematic flow chart of a security method of the preferred embodiment according to the present invention is shown. According to the present invention, the security method is suitable for a computer system. In step S41, at least one file 10 is monitored. In step S42, there is a change operation to the at least one file 10. Prior to the change operations of the at least one file 10 occur, a recovery point is created. In step S43, message of the change operation and the recovery point are recorded.

Afterwards, if the computer system goes not well, message of the change operation and the recovery point can be retrieved. One of the at least one recovery point for recovery operation is selected. The retrieved recovery point is previously created prior to the appearance of infection of virus, spyware, Trojan or other security threats. The retrieved recovery point can be the latest created one.

The present invention ensures the recovery operation due to the message of change operation and the recovery point are recorded. Hence, the shortcoming that the computer system cannot be restored to a normal state can be entirely avoided.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A security system, which is suitable for a computer system having at least one file stored therein, said security system comprising:
a creating module for creating at least one recovery point;
a monitoring module for monitoring a change operation to said at least one file;
a recording means for recording predetermined message of said change operation; and
a detecting module for detecting whether or not said computer system is being infected by virus, spyware, Trojan or other security threats,
wherein said creating module creates said at least one recovery point prior to said change operation of said at least one file, message of said at least one recovery point is respectively recorded in said recording means, and one of said at least one recovery point is retrieved for recovery operation.

2. The security system according to claim 1, wherein said message of said at least one recovery point includes creating time of said at least one recovery point.

3. The security system according to claim 2, wherein said retrieved recovery point is created prior to the appearance of infection of virus, spyware, Trojan or other security threats.

4. The security system according to claim 3, wherein said retrieved recovery point is the latest created one.

5. A security system, which is suitable for a computer system having at least one file stored therein, said security system comprising:
a creating module for creating at least one recovery point;
a monitoring module for monitoring a change operation to said at least one file;
a recording means for recording predetermined message of said change operation; and
a processing module for processing a recovery operation after said computer system is being infected by virus, spyware, Trojan or other security threats, in accordance with message of said at least one recovery point.

6. The security system according to claim 5, wherein said message of said at least one recovery point includes creating time of said at least one recovery point.

7. The security system according to claim 6, wherein said retrieved recovery point is created prior to the appearance of infection of virus, spyware, Trojan or other security threats.

8. The security system according to claim 7, wherein said retrieved recovery point is the latest created one.
